(19) United States
(12) Patent Application Publication
(10) Pub. No.: US 2021/0217113 A1
(43) Pub. Date: Jul. 15, 2021

(54) DATA SECURITY SYSTEM AND METHOD FOR ELECTRONIC PAYMENTS

(71) Applicant: Trust Funds, LLC, Blaine, MN (US)

(72) Inventors: Lynn Leegard, Blaine, MN (US); Karen Hauer, Eagan, MN (US); Terry Hauer, Eagan, MN (US); Dawn Lunde, Lakeville, MN (US); Greg Selner, Apple Valley, MN (US); Dan Selner, West Saint Paul, MN (US); Cody Osegard, Franklin, TN (US)

(21) Appl. No.: 17/216,111

(22) Filed: Mar. 29, 2021

Related U.S. Application Data
(63) Continuation-in-part of application No. 15/004,550, filed on Jan. 22, 2016.
(60) Provisional application No. 62/106,626, filed on Jan. 22, 2015.

(51) Int. Cl. G06Q 50/16; G06Q 40/02; G06Q 20/38

(52) U.S. Cl. CPC G06Q 50/16; G06Q 20/382; G06Q 40/025

(57) ABSTRACT

A data security method and system are disclosed that electronically processes payment transactions, such as earnest money payments for real estate transactions to assist in securely moving data and payments from a bank account into a designated trust account while bypassing unsecure, intermediate steps and processes. Although it is standard practice for a buyer's payment to be handled by the buyer, the buyer's agent, the listing agent, and the broker or designated trust account holder before the check is deposited to a trust account at a bank, due to the high number of entities that handle the payment, the optimal transaction security may not be obtained by the standard practice. Finding a solution for the optimal transaction security may require minimizing the number of entities that handle payments and minimizing distribution of confidential information, particularly if the confidential information involves specific bank account details. The benefits are, among others, more direct and more secure movement of payment information amongst transacting entities, programmatic determination of the appropriate trust account based on preset rules for a specific designated trust account holder, and real-time status notifications.

### CROSS-REFERENCE TO RELATED APPLICATION

This application is a continuation-in-part of U.S. patent application Ser. No. 15/004,550 filed Jan. 26, 2016, currently pending, titled DATA SECURITY SYSTEM FOR ELECTRONIC PAYMENTS which claims the benefit of U.S. Provisional Patent Application Ser. No. 62/106,626, now expired, filed on Jan. 22, 2015, titled SECURE TRANSACTION SYSTEM. These applications are herein incorporated by reference in their entirety.

### FIELD OF THE DISCLOSURE

This disclosure generally relates to a data security system that electronically processes payment transactions. More specifically, the present disclosure relates to a system that securely moves data and payments from a first bank account directly into a designated trust account while bypassing unsecure, intermediate steps and processes.

### BACKGROUND OF THE INVENTION

Real estate agents represent both buyers and sellers in transactions. Historically most, if not all, of the communication and paperwork for real estate transactions has been done in person. In the past few years, the real estate industry has shifted to allow and provide electronic processes for how documents and contracts are completed, signed, delivered, stored and managed. Although the legal and financing processes and documentation have transitioned to online and digital solutions, the handling of earnest money associated with these electronic transactions continues to be reliant on the physical delivery of paper checks due to many challenges.

Real estate is a highly regulated industry. All 50 states have licensing statutes that govern activities. The regulations can govern which activities are required, permitted, and prohibited. One area that is of particular concern to regulators is the manner in which licensees, whether a real estate broker, title company, escrow company, or law firm handle money received in a fiduciary capacity. This includes earnest money as part of a real estate transaction. The regulators are concerned about the timeframe for delivery and deposit of payments and tracking of the payments deposited into and refunded out of any licensee's trust account.

Although it may vary slightly from state to state, there is a required timeframe for when earnest money must be delivered and ultimately deposited into a trust account. This timeframe may be mandated by state statute or by agreement between the buyer and seller in a purchase agreement. The required timeframe dictated by state statute is typically very short (as little as two business days in some states, and three business days in many other states). Unfortunately, the antiquated method of writing paper checks and physically delivering them is often not done within the constraints of the time requirements.

In addition, the holder of a trust account is required to track when earnest money is received in order to demonstrate that a deposit was made within the required timeframe. This may be especially cumbersome and difficult when the real estate broker is holding the earnest money in its trust account because “receipt” may occur when the real estate agent within the company receives the check, not when the broker or its office receives it. That requires the broker to manually track the date of receipt and to rely on information provided by its agents. Trust account holders are also required to keep accurate information about the activity in their trust account by documenting when funds are deposited, accounting for all of the funds and matching them to a particular transaction.

As part of a loan application and approval for a mortgage, a borrower is required to demonstrate to a lender that the funds used for the purchase are, in fact, that of the borrower. Currently, it is typical for a buyer to write a paper check for the earnest money. The lender, however, before giving the buyer credit at closing for the amount of the earnest money, requires that the buyer demonstrate that the money actually came from the buyer's personal bank account. This obligation is a cumbersome process requiring the buyer to provide the lender with a full bank statement along with a physical copy of both the front and the back of the earnest money check. The physical copy of the check is required, since in many instances a bank statement does not provide sufficient detail on who received the payment.

Earnest money payments in a real estate transaction are unique from other payment transactions. The buyer does not typically have a direct connection or communication with the company to which it is making the earnest money payment; and yet the funds must go from the buyer's bank account to the designated trust account.

Lastly, as the rest of the industry continues to be more digitally based, an increasing number of consumers simply do not have a checking account; or may have such an account but may not order or own physical paper checks. In order for these buyers to make their earnest money payment, they often must go to the trouble and expense of obtaining a cashier's check. This will result in the buyer's bank account appearing as if it had a large cash withdrawal with no documentation as to where the funds went, again causing an obstacle in the financing process. Another option in these cases is for the buyer to pay their earnest money by wire transfer, which can add on additional fees to an already large expense, and which requires the designated trust account holder to disclose to the buyer the bank account information for its trust account.

Therefore, in order to comply with contract terms, state regulations and lender requirements for both the timely deposit into a designated trust account and the strict documentation of earnest money payments, a physical paper check often must be driven from the buyer to the buyer's agent, and finally delivered to the designated trust account holder which may be the buyer's broker, the listing broker, a title company, an escrow company or a law firm where the check is finally processed and delivered to the bank for deposit. While it may be possible that the physical delivery of paper checks may comply with applicable rules, it certainly can be inconvenient. In addition, the use of a paper check poses other serious issues.

In today's real estate market, many real estate agents and brokers work in very widespread geographic areas. Therefore, the physical delivery of earnest money checks is a much bigger burden in transactions than it historically was when agents and brokers tended to focus on a small geographic market. The USPS, messenger services, or overnight delivery services can be costly and unreliable alternatives and may create difficulty in documenting the date on which the designated trust account holder received the check and not meet the strict timelines required. In addition, using these delivery methods does not provide for the ability to properly track the status of the payment or control who actually receives and views the check and, therefore, unauthorized individuals may have access to the buyer's personal financial information.

Regulators are concerned about how a consumer's personal financial information is secured. A buyer's personal and financial information, including their full bank account number, appears on the face of the paper check and passes through many hands before it is finally deposited into the designated trust account. The parties that may have access to the buyer's information may be the real estate agents, brokers, including office and accounting staff, title companies, escrow companies, law firms, and their staff and lenders, including loan officers and their staff. Additionally, it is not uncommon for individuals involved in a transaction to keep a paper copy of the check in a transaction file. This creates a great risk of potential identify theft, as well as potential liability for every person and company responsible for the secure handling of the paper check.

Another issue is the lack of information regarding the status of the earnest money payment. Once a buyer hands over the earnest money check to the buyer's agent, the buyer has no way of tracking who has the check and when it is deposited into the designated trust account. In addition, other parties involved in the transaction cannot track the status of the earnest money payment. For example, the designated trust account holder, whether it is a buyer's broker, listing broker, title company, escrow company, or law firm, does not know when to expect delivery of the earnest money check. Plus, if the paper earnest money check is returned by the buyer's bank for any reason, including, for example, non-sufficient funds, that bank notification process can take up to ten business days. This lengthy period of time creates a risk for sellers in a transaction since they believe that the designated trust account holder is holding the buyer's earnest money when in fact, it is not. Notifying the buyer and all other interested parties in the transaction of the return and obtaining a new check starts the long process all over again, which could severely jeopardize the real estate transaction.

Finally, another issue caused by the physical handling of paper earnest money checks is the frustration over the very manual and slow process of refunding the buyer's earnest money in the event a purchase agreement is canceled. First, the designated trust account holder must verify that the earnest money has in fact settled in the trust account. Failure to do so may result in returning money to a buyer from a trust account that has not yet been received and may not be received if the check is returned, causing a regulatory issue with the trust account. For this reason, the designated trust account holder may require ten to even as many as 30 days to lapse after the deposit before producing and mailing a physical check back to the buyer. This too may create a regulatory issue, since many licensing statutes have specific timeframes regulating when earnest money must be released from a trust account following a cancelation of a purchase agreement. In addition, a delay in returning the earnest money may cause significant issues for the buyer. For instance, the buyer may need those funds to pay earnest money required by a purchase agreement for a different real estate transaction.

Therefore, a system is needed that is secure, web-based, available to all parties in a real estate transaction, and capable of handling every step of the earnest money payment process including, if necessary, a return of the buyer's earnest money in the event of a cancellation.

### SUMMARY

The disclosed transaction system is a secure, web-based solution that provides for the electronic processing of payments from a buyer's bank account into a designated trust account. According to some embodiments of the present disclosure, the disclosed transaction system can be applied to real estate transactions and the payment can be an earnest money payment. The disclosed secure transaction system provides real-time notification of transaction status to all parties involved in the transaction. Each step in the process of the money payment, from the buyer submitting the payment, to the funds settling in the designated trust account, are date and time stamped for clear and complete reporting and auditing purposes by all applicable parties. Additionally, because the transaction is processed electronically from the buyer's bank account to the designated trust account, the buyer's bank account can record the transaction with much greater detail than what would be recorded with a paper check.

Further, refunding a buyer's money payment can be processed electronically in the disclosed secure transaction system upon real-time notification that the money payment has settled, which results in a much faster refund to the buyer. In addition, the refund can be processed without re-entering the buyer's bank account information or providing the buyer with a paper check from the designated trust account. A paper check from the trust account would result in the buyer having access to the bank account information of the trust account. An electronic refund provides that the trust account information remains secure without sharing it with a consumer. The buyer and all parties are notified when a refund is processed electronically through the disclosed transaction system with a full transaction detail including date and time stamp and the status of the transaction.

In one aspect, a method of conducting a secure automated real estate financial transaction is disclosed involving a buyer and a seller. The method includes registering a designated trust account holder with a web-based transaction system. The system also stores rules for mapping the trust account key to a designated trust account. These rules are set up by the algorithm and match buyer-specific data to property-specific data. Examples of these rules contained in the algorithm can include buyer account information, location of the buyer, other properties of the buyer as they relate to the intended purchase transaction and property specific information such as location of the property, identification of the proper MLS, conformation to the rules and statutes of the state in which the property is located. The buyer or the buyer's agent can be in electronic communication with the web-based transaction system. The disclosed method also includes storing buyer-specific information such as the buyer's contact information, buyer's identification information, buyer's bank account information, etc. in a database in the web-based transaction system. The method further includes identifying a real estate property that the buyer intends to purchase, locating the property in a multiple listing system (MLS), transferring property-specific date from the multiple listing system to the database, and mapping the property-specific data for the property and the buyer-specific information to obtain the trust account key of the broker stored in the database. The property-specific data can include the MLS identification number, the property location, address, etc. The trust account key can designate a designated trust account. The disclosed method also includes the web-based transaction system sending an earnest money request to the buyer followed by the buyer sending the earnest money to an ACH processor. The disclosed method additionally includes the ACH processor creating an ACH transaction and transmitting it to the federal ACH banking system for processing. Finally, the method includes the ACH system debiting the buyer's bank account and crediting the designated trust account.

A fully executed purchase agreement for a real estate transaction can provide the terms and conditions agreed to between a buyer and seller regarding the buyer's earnest money payment. Such terms can include the amount of the earnest money and the named entity charged with receiving and holding the earnest money. That entity is herein referred to as the “designated trust account holder” or “DTAH”. The designated trust account holder may be dictated by state statute or may be determined through negotiation between the buyer and seller. In some real estate markets, it is standard practice to deposit earnest money payments into the listing broker's trust account. In other markets, it is standard practice to deposit earnest money payments into the buyer broker's trust account. And in other real estate markets, the buyer and seller may negotiate as part of the purchase agreement to deposit earnest money payments to a trust account with a specified title company, escrow company, or law firm, any of which may also be involved in closing the real estate transaction.

In another aspect, an earnest money payment system for a secure real estate transaction is disclosed that includes a computing device in electronic communication with a web-based transaction system. The web-based transaction system can include an algorithm that matches a designated trust account to a specific real estate property to be purchased. The disclosed system also can include a buyer and/or buyer a computing device in electronic communication with a web-based transaction system. The buyer has a bank account and can agree with a seller to sell the specific property to the buyer. The disclosed system also includes the designated trust account identified by the algorithm for the specific property, where the designated trust account can be structured and configured to securely receive and hold an earnest money payment deposited by the buyer. The disclosed system also includes a trust account key generated by the designated trust account, the trust account key, ensuring that the earnest money payment is securely deposited into the designated trust account. The disclosed system passes the buyer's bank account to an ACH processor in the ACH banking system.

The ACH processor can create an ACH transaction and submit it to the ACH banking system. The ACH Banking System can debit the buyer's bank account and can credit the designated trust account with the earnest money deposited by the buyer.

The disclosed transaction system can generate and store an internal trust account key for each trust account that a DTAH may have in a database and can store rules for mapping the trust account key to a designated trust account. The trust account key can provide that the system can accurately, and without human intervention, determine the correct trust account based on the rules, and direct funds to the appropriate bank account through the Automated Clearing House (ACH) processor. The method can further include providing the buyer with electronic communication with the web-based transaction system allowing the storage of buyer-specific information in a database of the web-based transaction system. The buyer-specific information can include the buyer's bank account information. The disclosed method can further include identifying a real estate property that the buyer intends to purchase and locating the real estate property in a multiple listing system (MLS). Property-specific data from the multiple listing system can be transferred to the database. The property-specific data for the property can be mapped with the buyer-specific information to obtain the correct trust account key of the DTAH stored in the database.

The trust account key can designate a specific designated trust account. The web-based transaction system can pass the buyer-specific information, the earnest money amount, and the correct trust account credentials based on the trust account key to the ACH processor. The ACH processor can create an ACH transaction and can transmit the ACH transaction to the federal ACH banking system for processing. Finally, the ACH system can debit the buyer's bank account and credits the designated trust account.

### BRIEF DESCRIPTION OF THE DRAWINGS

FIG. 1 illustrates one example of the process described in the present disclosure.

FIG. 2 illustrates an algorithm used by the disclosed system to determine the trust account according to one embodiment of the present invention.

FIG. 3 illustrates a comparison of the traditional earnest money process and the disclosed invention.

FIG. 4 is a schematic block diagram depicting an example computing system used in accordance with one embodiment of the present invention.

FIG. 5 is a schematic block diagram that illustrates an example of a portion of the disclosed web-based system and method that involves matching done by the system in accordance with the rules provided by the broker.

FIG. 6 is a schematic block diagram that illustrates an example of the workflow of the disclosed system and method.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

The disclosed secure transaction system is directed to a secure, web-based solution that provides for the electronic processing of payment transactions, such as an earnest money transaction, to securely move data and payments from a buyer's bank account into a designated trust account while bypassing unsecure, intermediate steps and processes. It is standard practice for a buyer's payment to be handled by the buyer, the buyer's agent, the listing agent, and the broker or designated trust account holder before the check is deposited into a trust account at a bank. Due to the high number of entities that handle the payment, the optimal transaction security may not be obtained by the standard practice. Finding a solution for the optimal transaction security may require minimizing the number of entities that handle payments and minimizing distribution of confidential information, particularly if the confidential information involves specific bank account details. Accordingly, the benefit can be more direct and more secure movement of payment information amongst transacting entities.

The disclosed system can be used, for example, as part of a real estate transaction. In some embodiments, the system can be used by real estate brokers, title companies, escrow companies, law firms, and any other firms that accept and hold earnest money in a fiduciary capacity and/or perform closing services for real estate transactions. These companies benefit because the system allows buyers a convenient and secure method to deposit their money prior to closing without the inconvenience and high cost associated with a cashier's check or wire transfer. The functions of the disclosed system are more fully described below.

In addition to meeting the requirements of contract terms of all the industry rules, regulations, and lending requirements for both the timely deposit and documentation of earnest money payments, the disclosed secure transaction system can provide real-time notification of transaction status to all parties involved in the transaction including buyers' agents, buyers' brokers, listing agents, listing brokers and any other designated trust account holder that receives the earnest money payments such as title companies, escrow companies, or law firms. Each step in the process of the earnest money payment, from the buyer receiving the earnest money payment request, to the buyer opening the payment form and submitting the earnest money payment, to the funds settling into the designated trust account, can be date and time stamped for clear and complete reporting and auditing purposes by all applicable parties. Further, because the transaction is processed electronically from the buyer's bank account to the designated trust account, the buyer's bank account can record the transaction with much greater detail than what would have been recorded with a paper check. This can eliminate the need for the buyer to provide a lender with the front and back of an earnest money check. Additionally, in some embodiments, the lender may receive a payment history report that identifies, among other details, the buyer's name and a portion of the buyer's bank account number, which can satisfy the lender requirement of documenting the source of funds.

Additionally, refunding a buyer's earnest money payment can be processed electronically in the disclosed secure transaction system upon real-time notification that the earnest money payment has settled, which results in a much faster refund to the buyer. In addition, the refund can be processed without re-entering the buyer's bank account information or providing the buyer with a paper check from the designated trust account. A paper check from the trust account would result in the buyer having access to the bank account information of the trust account. An electronic refund provides that the trust account information remains secure without sharing it with a consumer. The buyer and all parties are notified when a refund is processed electronically through the disclosed transaction system with a full transaction detail including date and time stamp and the status of the transaction.

While processing financial transactions from one bank account to another bank account through the ACH System is an activity that already exists, there are several distinctions in how the disclosed secure transaction system functions that are unique. For example, the disclosed secure transaction system can bring together, in an online community, all parties involved in both sides of the earnest money payment transaction, thereby providing access to critical information about the status of the earnest money payment. Knowledge of this information is not available through any other current system. There is no other single system available today where buyers of real estate can (1) securely and timely submit their earnest money payment electronically into a designated trust account and (2) provide accurate, timely, and detailed status information about the earnest money payment to parties on the buyer's side of the transaction, the listing side of the transaction, and to all other parties involved in the transaction.

The disclosed secure transaction system can partner with an ACH Processor, which is an entity responsible for creating and submitting transactions to the ACH banking system. The ACH processor can provide the disclosed transaction system with credentials specific to each trust account it underwrites. When transaction information including the trust account key is submitted, the transaction system can select the associated credentials tied to this trust account key and sends them to the ACH Processor, resulting in the buyer's bank account being debited, and the correct trust account credited. The ACH Processor can send real-time status information to the disclosed secure transaction system at each stage of the transaction.

Designated trust account holders that receive earnest money payments may maintain more than one trust account for the purposes of holding earnest money payments. Additional accounts may be required by state regulations or may be created by choice for a lawful business practice. For example, the account holder may create additional accounts to segregate funds for different types of transactions. There may be separate trust accounts for each office or group of offices within a designated trust account holder company. There may be a separate trust account designated to hold earnest money payments for each state in which properties are located. The disclosed transaction system has created an algorithm to ensure each earnest money payment is deposited into the correct trust account without human interaction.

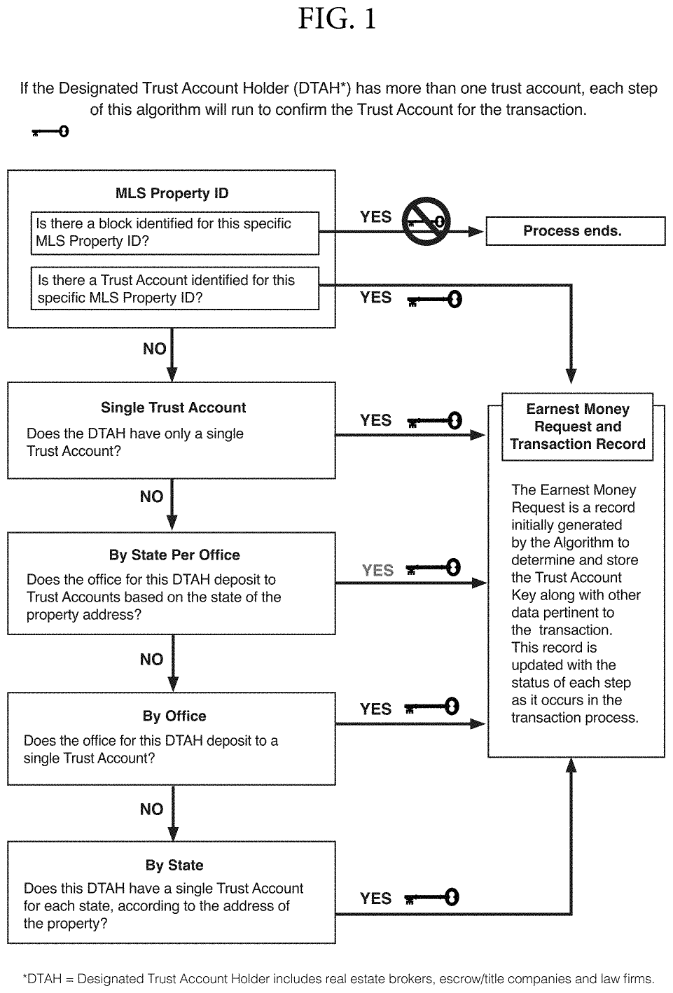

When a buyer's real estate agent initiates the process to send an earnest money payment request to the buyer, the disclosed transaction system will run each step of the algorithm, as illustrated in FIG. 1, in order to determine the correct trust account to use for the transaction. More specifically, the system will ask if there is a block identified for the specific property identified in the earnest money request. If there is, the process will end. If not, the system will ask if there is a trust account identified for the specific property. If there is an identified trust account, the trust account key will be sent and stored in the “Earnest Money Request and Transaction Record.” If there is no identified trust account for the property, the system will next ask if the designated trust account holder has a single trust account. If the answer is “yes”, the trust account key will be sent and stored in the “Earnest Money Request and Transaction Record.” If the answer is “no”, the system will then ask if the office for the designated trust account holder deposits to trust accounts based on the state of the property address. If the answer is “yes”, the trust account key correlating to that specific office and state can be sent and stored in the “Earnest Money Request and Transaction Record.” If the answer is “no”, the system will then ask if the office for the designated trust account holder deposits to a single trust account. If the answer is “yes”, the trust account key correlating to that specific office will be sent and stored in the “Earnest Money Request and Transaction Record.” If the answer is “no”, the system will then ask if the designated trust account holder has a single trust account for each state, according to the address of the property. If the answer is “yes”, the trust account key correlating to that specific state will be sent and stored in the “Earnest Money Request and Transaction Record.”

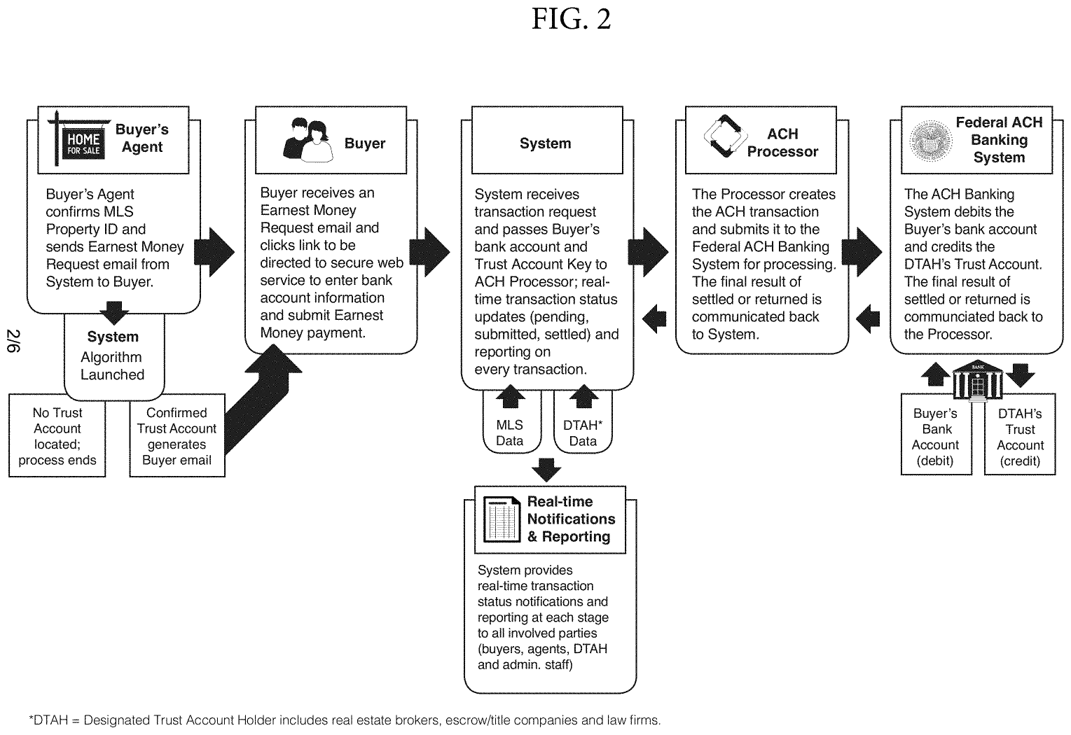

Therefore, in summary, if the property is flagged to block an electronic earnest money payment or if no trust account is located, the real estate agent will not be able to send the earnest money request to the buyer, and the buyer will be required to submit the earnest money payment by some other means. However, if a trust account is found, the disclosed secure transaction system continues its process, as illustrated in FIG. 2. More specifically, the system confirms that it has determined the correct trust account for the property and will generate an email for the buyer that contains an earnest money request hyperlink. Next, the buyer can click the earnest money request hyperlink to be directed to a secure web service where the buyer can enter bank account information and submit the earnest money payment. After the buyer submits the payment, the system can pass the buyer's bank account and the credentials corresponding to the specific trust account key to the ACH processor, ensuring the funds are securely deposited into the correct trust account. The ACH processor can create the ACH transaction and submit it to the Federal ACH Banking System for processing. The ACH Banking System will debit the buyer's bank account and credit the designated trust account holder's trust account and then communicate back to the ACH Processor whether the final result of the transaction is settled or returned. This final result (settled or returned payment) can be communicated back to the disclosed system by the ACH processor. In addition to this process, the disclosed system can provide real-time transaction status notifications and report updated statuses at each stage to each party that is involved in the transaction (ex: buyers, agents, designated trust account holders and any administrative staff, etc.).

The disclosed secure transaction system is a unique software-as-a-service (“SaaS”) that connects consumers (i.e. buyers), real estate agents, and designated trust account holders in a secure environment for collecting, processing, tracking, managing, and reporting earnest money payments. In addition to the unique processes used by the disclosed secure transaction system, the system can collaborate with other services to supply accurate reporting and data and the ACH processing services.

First, the disclosed secure transaction system can collaborate with a multiple listing service (“MLS”) to provide limited, but accurate, current property listing data that becomes part of each earnest money transaction. The MLS can provide broker and agent member data, broker and agent transaction history data, permission to receive and use MLS data, can provide promotional activities to encourage broker and agent participation. The MLS can pay a monthly subscription fee to the disclosed secure transaction system. Therefore, buyers' agents are able to use the disclosed secure transaction system at no additional charge and may facilitate an earnest money request for the buyer as long as the designated trust account holder is a member of the disclosed secure transaction system. A buyer's agent can assist the buyer in electronically submitting an earnest money payment, can receive all notifications, and can have the ability to view transaction and history reports even if the agent's own broker has not yet subscribed to the disclosed secure transaction system to receive earnest money payments.

All designated trust account holders must register with the disclosed system. For example, a designated trust account holder can register by clicking on a registration button on a website hosted by the system. The first step for the designated trust account holder is to select the MLS market in which they do business. Next, the designated trust account holder can select the appropriate member type. The various member types include, but are not limited to, broker, title company, escrow company, and law firm.

### Brokers as a Designated Trust Account Holder

The disclosed secure transaction system can be easy to use and can save all parties the liability and time-consuming hassle of delivering paper earnest money checks from buyers to the designated trust account holder. Plus, the disclosed system can greatly streamline the earnest money process and provides constant tracking and reporting capabilities.

Real estate brokers can register with the disclosed secure transaction system and pay a monthly subscription fee. In some embodiments, brokers may register to have access to transaction data only and may not receive electronic earnest money payments to a trust account but may still have access to transaction data for transactions involving its company. In other embodiments, brokers may register to have access to transaction data and to have additional authority, such as the ability to receive electronic earnest money payments. In order for a broker to receive earnest money payments through the system, the broker must use the disclosed ACH processor to activate an ACH processing account for each of the trust accounts for which the broker wishes to receive earnest money payments.

A broker can register to use the disclosed system by completing an authentication and a registration process that utilizes data from the broker's MLS. To begin the process, the broker can select the MLS market it wishes to register for and can enter its MLS identification number. In order to initiate the registration process, the broker can authenticate the broker's organization. Broker information from the MLS can then display, and the broker or staff member that is completing the registration process can populate information to create the broker account. The information can include, but is not limited to, the legal business name, an assumed name, the officer's or owner's name, the officer's or owner's title, the contact's first name, the contact's last name, the contact's phone number, the contact's email, and a newly created password.

In some embodiments, after the broker provides the above-described information, the broker will receive an authentication email at the email address the broker provided. The email can provide a link that will enable the broker to log in and finalize the authentication process. Once authenticated, the broker can be presented with all applicable fees (which are determined from the broker record in the disclosed transaction system's database) and a summary of the registration steps along with a checklist of the required documentation required for opening an ACH financial account with the ACH processor.

In some embodiments, the broker is permitted to review and accept the terms of the service agreements of the disclosed transaction system and the ACH vendor as well as the terms and conditions.

In some embodiments, the broker is enabled to provide the information required to activate an ACH account, which enables the broker to receive electronic earnest money payments into a designated trust account(s). As part of the application, the broker can indicate whether his or her organization has one or more trust accounts. If the broker has more than one trust account, the broker can open an ACH account for each trust account. Earnest money payments to the proper trust account are based upon the system's algorithm, as described earlier. If the broker responds that the company has multiple trust accounts, a notification is sent to the disclosed secure transaction system's support staff to provide the broker with a multiple trust account form to define how the trust accounts are managed within the broker's organization.

In some embodiments the broker is enabled to upload the required supporting documentation to verify identification of the broker, documentation for the broker's trust account(s) and the broker's operating account so the ACH account(s) can be underwritten. The disclosed secure transaction system can provide detailed guidance on what documents satisfy the requirements and can allow the broker to upload documents of each type for all accounts.

In some embodiments, the broker can be advised that the account activation is in process and that the broker must wait until the ACH account is underwritten and activated. Once the ACH account is activated, the system can auto-generate a debit transaction of a random dollar amount to each trust account to ensure the transaction appears in the broker's trust account(s). A notification email can be sent to the broker indicating the broker should view its bank account to locate the debit amount of the test transaction and then log in to the disclosed system to confirm such amount. A corresponding credit transaction in the same amount as the debit transaction is generated after the debit transaction has been verified, thereby balancing the broker's trust account. In some embodiments, the system does not auto-generate debit/credit transactions to the broker's operating account, but rather the initial service fee transaction that is processed is used to verify that account.

Once the broker has entered the correct debit amount for the test transaction(s), the system can automatically activate the broker's account.

Once the broker's account is activated, and thereafter, the broker can enter the email address and password established during registration with the disclosed secure transaction system. Passwords must at all times meet a minimum set of security guidelines and may only be reset by the user via a one-time-use link sent to the registered email address for the account. In some embodiments, once logged in, the broker lands on the broker home page. The home page can contain shortcut icons. For example, a house icon can return the broker to the home page from anywhere in the site, the person icon can allow the broker to update its profile, including email preferences and view its fee schedule, and the arrow icon can log the broker out of the disclosed secure transaction system.

A menu bar at the top of the home page may exist and contain several action options (tabs). One tab, when selected, can list all of the offices for the broker as provided from the MLS database. Another tab can list all of the agents associated with the broker as provided from the MLS database. Another tab, when selected, can provide the broker with reporting and functionality related to transactions and is described below. The available options provided by selecting a settings tab is also described below. A support tab, when selected, can provide contact information for the disclosed transaction system, including toll-free telephone, email, and the ability to submit a web ticket.

One of the tabs mentioned above, is part of the disclosed system that a broker may utilize to view at least two transactions tables. One table lists earnest money payments that have been made by the buyers of the broker. The other table lists earnest money payments made by buyers for properties listed by the broker. Both tables can include, in addition to a trust account nickname for the trust account into which the earnest money payment was deposited, the MLS number, the street address, city, state and zip, the buyer's name, and various transaction data such as, but not limited to, the date and time of the latest activity, the amount of the earnest money payment, the invoice number, and the payment status. The trust account nickname may be a critical feature for those brokers that have more than one trust account, and it can provide the broker with a visual confirmation of which trust account received a specific earnest money payment. The records in both tables can be displayed chronologically using the MLS number and the list can include all, or a portion, of the earnest money payment transactions that have occurred. Brokers may sort the data by a specific column or may filter the data using various filter options. For example, a broker can sort the data by searching for transactions for a specific office or a broker can enter a specific MLS number to locate a single record. Both tables can display an indicator of payment status, as more fully described below, along with the date and time of the last activity. There is also an explanation of the ACH processing timeline and a guide with the definitions of all statuses. For the transactions, there may be a mouse-over calendar icon that can display an expected settlement date.

An earnest money payment history report is available from the disclosed secure transaction system. The earnest money payment history report can include the MLS number, information about the property, the amount of the earnest money payment, the names of the agents and brokers for both sides of the transaction, the designated trust account, information about the buyer, the buyer's bank account, identification of the agent who sent the payment request and the status and date and time of each step of the payment process. In addition, access to the earnest money payment history report may be provided to a lender by the agent completing an access request including the lender's email address and generating a PIN (typically, a 4-digit number). The lender may receive an email notification from the disclosed system and upon providing the PIN, may have access to the history report to document the earnest money payment.

The disclosed system can also allow brokers to reconcile trust account(s). One or more preset deposit reports may allow for easy reconciliation of any and all trust accounts, for any date range needed. Each row in the deposit report can represent a single earnest money payment that was settled into the trust account, or a refund generated via the disclosed system back to a buyer. All transactions that settle to or from the account on a given day are totaled up for easy comparison to the broker's batch deposits in the bank statement, to ensure all funds going in and out of the account have a specific real estate transaction tied to them.

The disclosed system can allow for electronic refunding of earnest money payments, as noted earlier. When a purchase agreement is canceled, the agreement can dictate whether the buyer of the property is entitled to a refund, or in some cases a partial refund, of any earnest money paid. The transaction system can allow brokers to initiate an ACH transaction to refund all or part of an earnest money payment back to the buyer's bank account. The broker does not have the ability, or the need, to enter any bank account information—funds are sent from the designated trust account that received the deposit back to the buyer's bank account provided by the buyer and stored by the ACH processor for secure reference. This can ensure that both the broker's and the buyer's account information does not need to be shared with any other parties in order to facilitate an electronic refund. The trust account key from this specific “Earnest Money Request and Transaction Record” can again be used to provide the credentials for the correct trust account to an ACH processor. In some embodiments, the amount of the refund transaction is sent to an ACH processor as well, to allow for full or partial refunds. As with the original earnest money payments, the disclosed system receives real-time status updates from an ACH processor and provides notifications to all interested parties.

The designated system can allow for the broker to further manage the ACH transactions into and out of their trust account. Specifically, the disclosed system can provide the ability to “void” a payment prior to the transaction being submitted for processing to the ACH network. Typically, the ACH processor will batch and process all transactions at a set time of day, for instance at 7 pm CST on business days. Any earnest money payments that have been submitted but not yet processed in this batch can be voided, if needed, to stop the process and prevent the transaction from being posted to the ACH network. This may be needed for a number of reasons. For instance, if a buyer submits their payment but realizes the wrong bank account has been used, the buyer can request from the broker that the transaction be voided, prior to the ACH processor running the batch. This ability is provided only to the designated trust account holder. Once a “void” has been processed by the DTAH inside the disclosed system, the earnest money payment will not process, and all parties are notified of this update to the status.

In some embodiments, brokers can grant individuals in the organization permission (access) to view pre-determined transaction data in the system. In some embodiments, brokers can grant permission to add a user, complete the user record, and select the broker's offices to which the broker wants the user to have access. The disclosed system can filter transaction data to display information pertinent only to those office(s) to which the new user has access. In addition, brokers can edit or delete existing users. Access to these options gives brokers complete control over which users see what transaction data.

As discussed earlier, the disclosed secure transaction system is a unique system that allows buyers to deposit earnest money payments into a designated trust account, and if a broker has more than one trust account, the system's trust account key properly identifies the correct account. As an added feature, the disclosed system can allow brokers to review all of their trust accounts.

In some embodiments, the disclosed secure transaction system can display all of a broker's trust accounts by nickname along with a description of which earnest money payments should be deposited into each account. The disclosed secure transaction system can also identify the correct trust account for an earnest money deposit by using information and criteria previously set for each broker. Different types of trust accounts that the disclosed secure transaction system can identify include: (1) a specific trust account based on the MLS number of the property (this includes information in the system that can block earnest money transactions for specific properties); (2) a single trust account; (3) a specific trust account based on both the physical location of the property by state and the designated trust account holder's office location; (4) a specific trust account based on the designated trust account holder's office location; and (5) a specific trust account based on physical location of the property.

As another added security feature, the system can allow a broker to confirm that a specific earnest money payment for a specific property is “tied” to the correct trust account. The system can operate this feature by running the above-described algorithm program to determine and display the correct trust account for a specific MLS number. To confirm a correct trust account, the broker can enter an MLS number of one of the broker's listings and can then return identification of the trust account to the broker for verification that it is correct.

In addition, the disclosed system can allow a broker to make a selection for which email status notifications it wishes the system to send, and it can specifically identify the person(s) to receive such email notifications. These notification preferences may be customized for the broker's buyers' transactions and for the broker's listing transactions.

Brokers may also subscribe to use the disclosed system to process other types of transactions. In doing so, the disclosed system can be an effective tool for brokers to process refund transactions in the operation of their business.

### Other Designated Trust Account Holders

In addition to real estate brokers, buyers may use the disclosed secure transaction system to submit their earnest money payment to other designated trust account holders such as title companies, escrow companies, and law firms. Designated trust account holders that wish to receive electronic earnest money payments for transactions as part of their business model must also register with the disclosed secure transaction system and pay a monthly subscription fee. In order for the designated trust account holder to receive earnest money payments through the system, they can use the disclosed secure transaction system's ACH processor to activate an ACH processing account for each of the trust accounts to which the designated trust account holder wishes to receive earnest money payments.

A designated trust account holder can register to use the disclosed transaction system by first selecting the MLS market it wishes to register for. Next the designated trust account holder may select the appropriate member type, such as title company, escrow company, or law firm and provides the required company information such as company name, user's name, and user's email address. Next the designated trust account holder can complete the member authentication by entering additional company information. The company information requested can include address, city, state, zip, phone number, fax number, the number of real estate closings in the previous twelve (12) months, legal business name, DBA name, officer or owner name, officer or owner title, contact's first name, contact's last name, contact's phone number, contact's email address, and a newly created password.

In some embodiments, after the designated trust account holder provides the above-described information, the designated trust account holder can receive a confirmation email at the email address the designated trust account holder provided. The email can provide a link that will enable the designated trust account holder to log in and finalize the authentication process. Once authenticated, the designated trust account holder can be presented with all applicable fees (which are determined from the reported number of annual real estate transactions) and a summary of the registration steps along with a checklist of the documentation required for opening a financial account.

In some embodiments the designated trust account holder is allowed to review and to accept the terms of the service agreements of the disclosed transaction system and the ACH vendor, as well as the terms and conditions.

In some embodiments, the designated trust account holder is enabled to provide the information required to activate an ACH account, which enables the designated trust account holder to receive electronic earnest money payments into a designated trust account(s). As part of the application, the designated trust account holder can indicate whether its organization has more than one trust accounts. If the designated trust account holder has more than one trust account, it can open an ACH account for each trust account. Earnest money payments to the proper trust account are based upon the system's algorithm, as described earlier. If the designated trust account holder responds that the company has multiple trust accounts, a notification is sent to the disclosed secure transaction system's support staff to provide the designated trust account holder with a multiple trust account form to define how the trust accounts are managed within the designated trust account holder's organization.

In some embodiments, the designated trust account holder is enabled to upload the required supporting documentation to verify identification of the designated trust account holder and documentation for the trust account(s) and the designated trust account holder's operating account so the ACH account(s) can be underwritten. The disclosed secure transaction system can provide detailed guidance on what documents satisfy the requirements and can allow the designated trust account holder to upload documents of each type for all accounts.

In some embodiments, the designated trust account holder can be advised that the account activation is in process and that the designated trust account holder must wait until the ACH account is underwritten and activated. Once the ACH account is activated, the system can auto-generate a debit transaction of a random dollar amount to each trust account to ensure the transaction appears in the designated trust account holder's trust account(s). A notification email can be sent to the designated trust account holder indicating the designated trust account holder should view its bank account to locate the debit amount of the test transaction and then log in to the disclosed system to confirm such amount. A corresponding credit transaction in the same amount as the debit transaction is generated after the debit transaction has been verified, thereby balancing the designated trust account holder's trust account. In some embodiments, the system does not auto-generate debit/credit transactions to the designated trust account holder's operating account, but rather the initial service fee transaction that is processed is used to verify that account.

Once the designated trust account holder has entered the correct debit amount for the test transaction(s), the disclosed system can automatically activate the designated trust account holder's account. Once the designated trust account holder's account is activated, and thereafter, the designated trust account holder can enter the email address and password established during registration with the disclosed secure transaction system. Passwords must at all times meet a minimum set of security guidelines and may only be reset by the user via a one-time-use link sent to the registered email address for the account.

In some embodiments, once logged in, the designated trust account holder lands on the member home page. The home page can contain shortcut icons. For example, a house icon can return the user to the home page form anywhere in the site, the person icon can allow the user to update its profile, including email preferences and view its fee schedule, and the arrow icon can log the user out of the disclosed secure transaction system.

A menu bar at the top of the home page may exist and contain several action options. One tab, when selected, can list all the offices for the designated trust account holder provided by the designated trust account holder. Another tab, when selected, can provide the designated trust account holder with reporting and functionality related to transactions and is described below. The home page can also include a tab that, when selected, can include links to all training materials. A support tab, when selected, can provide contact information for the disclosed transaction system, including toll-free telephone, email, and the ability to submit a web ticket.

One of the tabs mentioned above, is a part of the system that a designated trust account holder may utilize to view a transaction table, which may list earnest money payments that have been made by buyers and deposited to the designated trust account holder's trust account(s). The transaction table can include, in addition to the trust account nickname for the trust account in which the earnest money payment is deposited, the MLS number, the street address, city, state and zip, the buyer's name, and various transaction data such as, but not limited to, the office, the date and time of the latest activity, the amount of the earnest money payment, the invoice number, and the payment status. The trust account nickname may be a critical feature for those designated trust account holders who have more than one trust account, and it can provide the user with a visual confirmation of which trust account received a specific earnest money payment. The records in the table can be displayed chronologically using the MLS number and the list can include all, or a portion, of the earnest money payment transactions that have occurred. Designated trust account holders may sort the data or may filter the data using various filter options. For example, a designated trust account holder can sort the data by searching for transactions for a specific office or a designated trust account holder can enter a specific MLS number to locate a single record. The transaction table can display an indicator of payment status along with the date and time of the last activity. There is also an explanation of the ACH processing timeline and a guide with the definitions of all statuses. For the transactions there may be a mouse-over calendar icon that can display an expected settlement date for transactions.

In some embodiments, designated trust account holders may access earnest money payment history reports, as described earlier. In addition, designated trust account holders may reconcile bank accounts, process refunds, and process voids of earnest money payments, as discussed earlier.

In addition, the disclosed system can allow a designated trust account holder to make a selection for which status email notifications it wishes the system to send, and it can specifically identify the person(s) to receive such email notifications.

Designated trust account holders may also subscribe to use the disclosed system to process other types of transactions. In doing so, the disclosed system can be an effective tool to process refund transactions in the operation of their business.

### Agents and Buyers

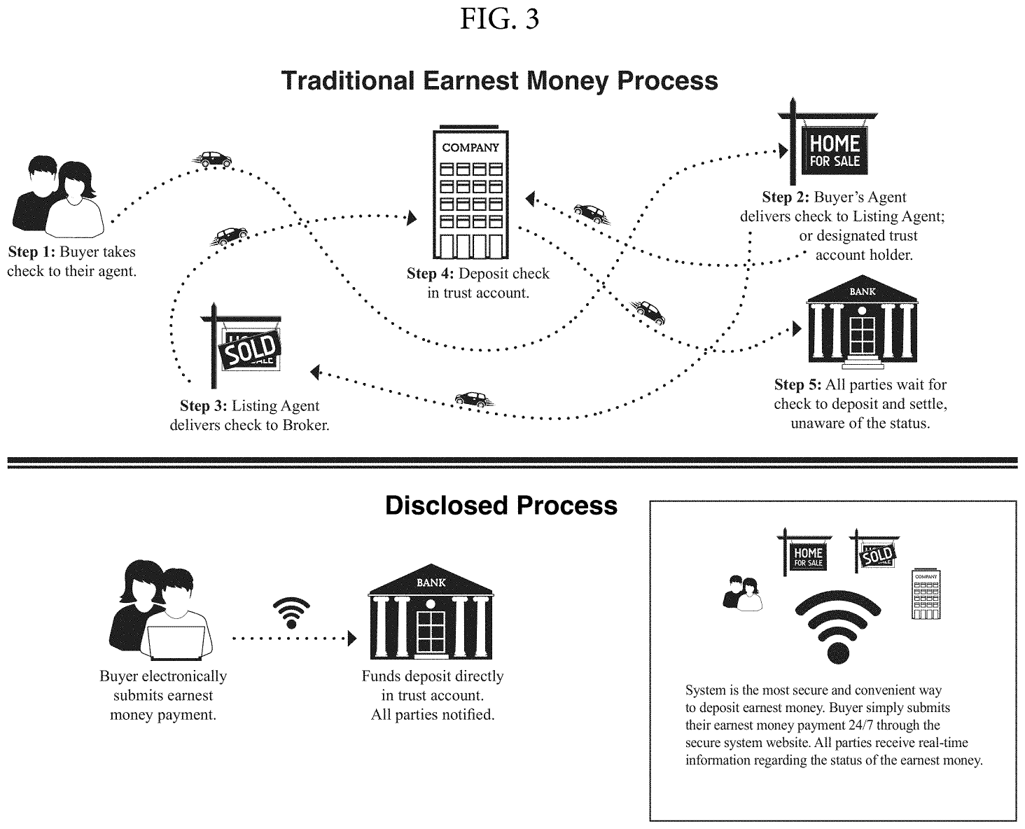

As described above, the disclosed secure transaction system, revolutionizes the antiquated method of physically delivering paper earnest money checks as part of real estate transactions. More specifically, as shown in FIG. 3, the traditional earnest money process involves a buyer taking a check to his or her agent and the buyer's agent delivering the check to a listing agent or other designated trust account holder. If delivered to the listing agent, the traditional earnest money process involves the listing agent delivering the check to the broker, the broker depositing the check into a trust account, and all parties waiting for the check to deposit and settle while remaining unaware of the status of the pending transaction. In the disclosed system, the process is streamlined, and all parties can receive real-time information regarding the status of the earnest money. More specifically, a buyer can electronically submit his or her earnest money payment and the funds can be deposited into the trust account. Agents can access the disclosed system via single-sign-on (“SSO”) technology directly from the applicable MLS system. The home page of the MLS system can display an icon for access to the disclosed transaction system.

In some embodiments, real estate agents can use the disclosed transaction system to send earnest money payment requests to buyers even if their broker has not subscribed to the system to receive electronic earnest money payments. This can enable agents to send an earnest money request and enables buyers to submit their earnest money payment to any designated trust account holder that has subscribed to the system even if the buyer does not have a direct business relationship with the designated trust account holder.

As each new MLS market is launched, all of the agents can be automatically registered. Agents may simply confirm the details of their profile by clicking on the disclosed transaction system's icon on, for example, the home page of the MLS. In some embodiments, the first time the agent generates an earnest money request, the agent can be prompted to accept the Terms and Conditions for use of the system.

In an agent's personal profile, the agent can provide a personal photo to be used in communications to the buyer. In addition, the agent may select which status email notifications the agent wishes to receive from the system. The default setting may be to receive all notices, and there may be an option to customize the email settings. Additionally, the agent profile can indicate the preference to either have the buyer pay the convenience fee or have the agent occasionally or always pay the convenience fee for each earnest money payment. The default setting for the convenience fee can be for the buyer to pay. If the agent elects to have the buyer always pay the convenience fee, the system may not require the agent to provide any personal banking information. If, however, the agent elects to always pay the convenience fee, or elects on a case-by-case basis whether to pay the convenience fee, the system may require the agent to enter his or her personal bank account information into his or her profile. The agent's bank account can be verified via an automated debit/credit transaction that is confirmed in a similar manner to the broker's and designated trust account holder's trust accounts. In some embodiments, if the account is not activated, the buyer will be asked to pay the convenience fee.

To support how the real estate industry operates in various markets, agents may have the option in their personal profile to designate other agents or assistants within their company to be part of their team. In some embodiments, an agent can create a team by searching and selecting from an available list of other MLS members in their company. This team function allows authorized individuals to initiate earnest money requests on behalf of the authorizing agent and, in some embodiments, to view the earnest money transaction data. Each team member can continue to maintain preferences in his or her profile regarding email notifications. However, the convenience fee payment for an earnest money transaction may be governed by the preference set by the authorizing agent in the authorizing agent's profile.

Upon final acceptance of a purchase agreement, the buyer's agent, as a member of the disclosed secure transaction system, begins the electronic earnest money payment process by locating the property the buyer is purchasing. The buyer's agent can locate the property by searching in the disclosed transaction system, the process of which will be more fully described below, by locating the property in the MLS web site, or by locating the property in the MLS mobile application.

After the property is located, the buyer's agent can initiate the earnest payment process in the MLS system by selecting the disclosed secure transaction system icon on the property detail page for the property. In some embodiments, the link may direct the buyer's agent to a modal window where the buyer's agent can select the required designated trust account holder that will receive the earnest money payment. The list of firms listed in the modal window will only include those firms that are members of the disclosed secure transaction system and have ACH processing accounts that have been activated to receive electronic earnest money payments. If the buyer's broker and/or the listing broker are not members of the system, they will be so designated.

Once the agent selects the required designated trust account holder, the agent may be directed to the earnest money payment request form within the disclosed secure transaction system. The buyer's agent can enter the buyer's name(s), email address, the required amount of the earnest money the buyer agreed to submit as part of the purchase agreement and a random word that will appear on the buyer's secure payment form. The agent may verbally share this word with the buyer so buyer may confirm the authenticity of the payment form. Additionally, the buyer's agent can certify that there is a fully executed purchase agreement between the buyer and seller of the property. The designated trust account holder and the responsible party for the payment of the convenience fee can also be displayed on this page. The agent can then trigger the disclosed secure transaction system to send the earnest money request to the buyer.

If the agent uses the database in the system to search for the property, all properties matching the search criteria are displayed. The agent can then select the listed property and the system can direct the agent to a modal window and the earnest money request, as described above.

In some embodiments, the disclosed secure transaction system can send the buyer an automated email that contains a secure, embedded link that the buyer can select to submit the earnest money payment. The earnest money payment form can be a web page pre-populated by the buyer's agent with the MLS property information and the amount of the earnest money payment required by the purchase agreement. One of the pieces of MLS data provided to the buyer can be an actual photo of the property. This can allow the buyer an easy visual confirmation that the buyer is submitting the earnest money payment for the property intended to be purchased. The buyer can provide the additionally required information for the payment including name on bank account, type of bank account (either checking or savings), bank routing number, and bank account number. In addition, the buyer can confirm the random word provided by the agent, authorize the transaction and approve payment of the convenience fee if the buyer is the party paying the fee. Once completed, the buyer can then allow the system to display a transaction confirmation on screen and may create a PIN to access a payment history report once the payment has fully settled, as described below.

In some embodiments, after the buyer has made an earnest money payment, the buyer has no further access to the disclosed secure transaction system. If the buyer has paid the convenience fee, the buyer may receive a second receipt for that payment.

In some embodiments, a buyer may create a unique access PIN upon completion of the earnest money payment, which can be used to access a detailed payment history report once the payment has fully processed and settled into the designated trust account. The disclosed system may send a notification email with a one-time-use link to the buyer upon notification of the settled status of the payment. The email may provide the buyer access to a web page in which they enter their access PIN and are provided access to the full payment history report. This report can be printed, downloaded as a file on the buyer's computer, and can be useful to a buyer to provide the lender and as proof of earnest money being paid in a timely manner.

In the event the buyer's agent sends the buyer a new earnest money request, the buyer's agent may be notified that a previous earnest money request has been made for the property. The agent can then be required to select one of three actions to continue such as (1) cancel the previous request and submit the new one; (2) keep the previous one and submit the new one; or (3) keep the previous one and do not submit the new one.

In some embodiments, the agent has access to view all of the transactions in the disclosed system for the agent's buyers and listings, and team transactions, if any, as described earlier. Details displayed on the transactions page are similar to the transaction table for brokers and designated trust account holders, as described earlier.

The transaction table made available to a buyer's agent provides them with additional specific functions, to assist the buyer with the earnest money payment. The buyer's agent may view the random word generated by the agent, as described earlier. The agent may edit the name or email address populated in the original earnest money payment request, to correct any mistakes in the original submission by the buyer's agent. This information may not be modified once a payment has been made by the buyer and has started processing in the ACH network. The buyer's agent may also resend the earnest money request email, to provide the buyer with the one-time-use access link in the event the buyer deleted or cannot locate the original email. Finally, the buyer's agent may choose to provide PIN-secured access to an outside, interested party to the payment history report. This is typically used to provide direct access to a lender or mortgage company to the proof of payment and allows for sharing of this detailed information without providing any transaction information via email. The buyer's agent creates an access PIN, similar to what a buyer may create as described above, and verbally provides that PIN to the third party. The third party can receive a one-time-use link via email, and can access the full payment history report in the same manner as the buyer, as described previously.

Designated trust account holders also may need to receive payments for services or for real estate transactions where the property is not listed in the MLS. Since the disclosed secure transaction system is dependent, in part, on data listed in the MLS, the system also offers three online payment solutions to members so they can receive payments for properties that are not connected to the MLS data.

The first online payment solution is an online bill pay product that is a customizable and secure online form branded for a member's website and that allows any consumer who links to the form to make an ACH payment to the member without requiring login access. Upon submitting the payment, the member and the consumer both receive an email receipt of the completed transaction. The member may have access to the disclosed system to view and manage these transactions.

The second online payment solution is a member portal that is a secure website customized and branded for members. The portal allows members to send data into this service via secure FTP (file transfer protocol) that provides buyers access to the portal. It also provides members with the ability to view and download information, such as payment requirements, to share securely with the buyer. The buyer may have the ability to provide response information and to make payments accordingly. Upon submitting the payment, the member and the buyer can both receive email receipts. The member can have access through the disclosed system to view and manage these transactions. Members may have access to consumer responses and data provided within the portal.

The third online payment solution is an application program interface (“API”) service that is utilized by members who have their own secure web-based system and desire to process secure ACH payments and have transaction status results returned to their own system. The member can have access to the disclosed system to view and manage these transactions.

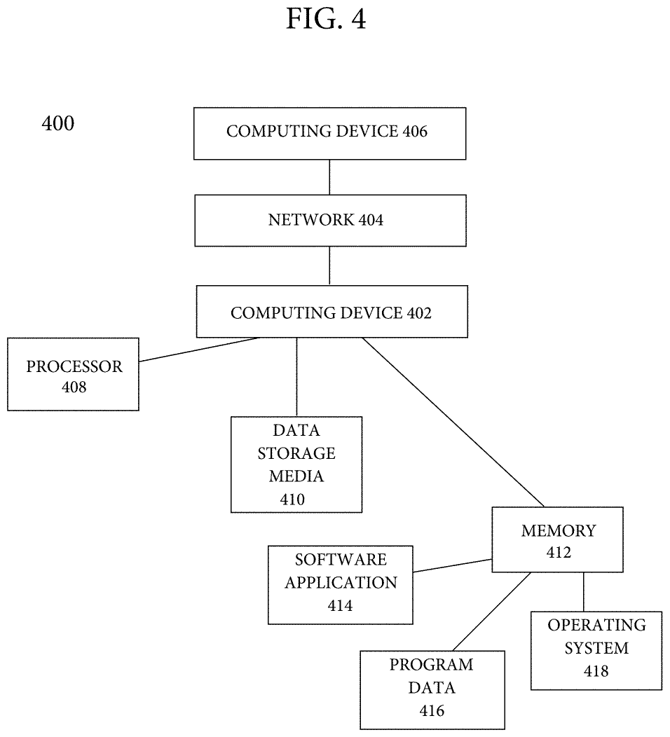

In some embodiments, the system described herein uses a computing system to carry out the various functions described herein. FIG. 4 is a schematic block diagram of an example computing system 400. The example computing system 400 includes at least one computing device 402. In some embodiments the computing system 400 further includes a communication network 404 and one or more additional computing devices 406 (such as a server).

The computing device 402 can be a computing device 402 located in a user's home or other place of business. In some embodiments, computing device 402 is a mobile device. The computing device 402 can be a stand-alone computing device or a networked computing device that communicates with one or more other computing devices 406 across a network 404. The additional computing device(s) 406 can be, for example, located remotely from the first computing device 402, but configured for data communication with the first computing device 402 across a network 404.

In some examples, the computing devices 402 and 406 include at least one processor or processing unit 408 and system memory 412. The processor 408 is a device configured to process a set of instructions. In some embodiments, system memory 412 may be a component of processor 408; in other embodiments system memory 412 is separate from the processor 408. Depending on the exact configuration and type of computing device, the system memory 412 may be volatile (such as RAM), non-volatile (such as ROM, flash memory, etc.) or some combination of the two. System memory 412 typically includes an operating system 418 suitable for controlling the operation of the computing device 402, such as the WINDOWS® operating systems or the OS X operating system, or a server, such as Windows SharePoint Server, also from Microsoft Corporation, or such as a Mac running OS X. The system memory 412 may also include one or more software applications 414 and may include program data 416.

The computing device 402 may have additional features or functionality. For example, the computing device 402 may also include additional data storage devices 410 (removable and/or non-removable) such as, for example, magnetic disks, optical disks, or tape. Computer storage media 410 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 410 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 402. An example of computer storage media 410 is non-transitory media.

In some examples, one or more of the computing devices 402 and 406 can be located in an establishment. In other examples, the computing device 402 can be a personal computing device that is networked to allow the user to access and utilize the system disclosed herein from a remote location, such as in a user's home, office or other location. In some embodiments, the computing device 402 is a smart phone tablet, laptop computer, personal digital assistant, or other mobile device. In some embodiments, system operations and functions are stored as data instructions for a smart phone application. A network 404 facilitates communication between the computing device 402 and one or more servers, such as an additional computing device 406, that hosts the system. The network 404 may be a wide variety of different types of electronic communication networks. For example, the network 404 may be a wide-area network, such as the Internet, a local-area network, a metropolitan-area network, or another type of electronic communication network. The network 404 may include wired and/or wireless data links. A variety of communications protocols may be used in the network 404 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 406 is a Web server. In this example, the first computing device 402 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 408 of the one or more computing devices 402 or 406, the instructions cause the processor 408 to perform one or more of the operations or methods disclosed herein.

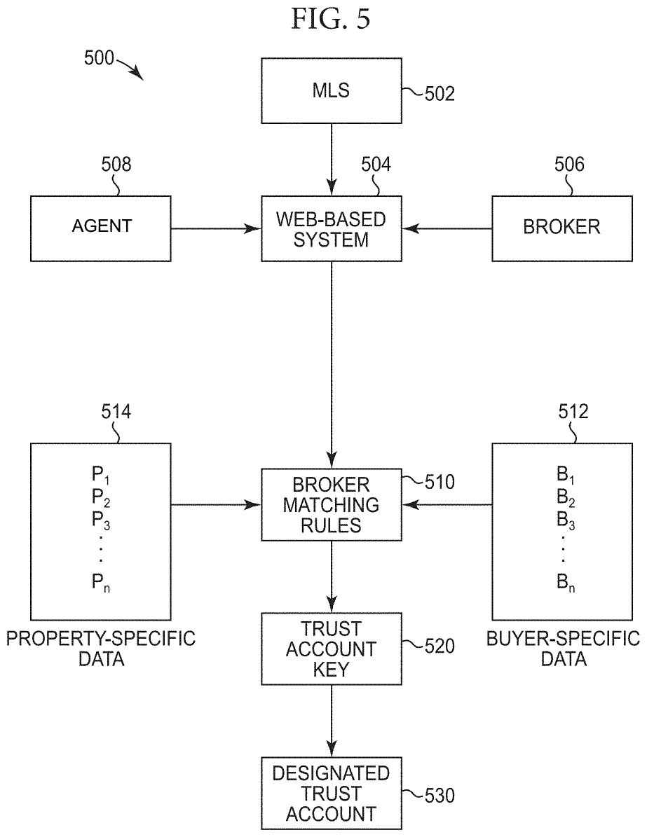

FIG. 5 is a schematic block diagram that illustrates an example of a portion of the disclosed web-based system and method that involves matching done by the system in accordance with the rules provided by the designated trust account holder, denoted as broker in this example. Schematic block diagram of disclosed system and method 500 illustrates broker 506 registered with web-based transaction system 504. Broker 506 establishes a set of rules 510 for mapping trust account key(s) 520 to specific designated trust account(s) 530. All of this information is stored in web-based transaction system 504. In the embodiment illustrated in FIG. 5, MLS system 502 is also in electronic communication with web-based transaction system 504.

The disclosed system and method of FIG. 5 illustrate agent 508 who, represents a buyer, is interested in purchasing a specific property. Agent 508 enters buyer specific data 512 (b₁, b₂, b₃, . . . bₙ) into web-based transaction system 504. Property specific data 514 (p₁, p₂, p₃, . . . pₙ) is available in web-based transaction system 504 from MLS database 502. Broker 506 for the specific property the buyer wants to purchase has stored broker matching rules 510 in web-based transaction system 504. Broker matching rules 510 allow mapping of buyer specific data (b₁, b₂, b₃, . . . bₙ) with property-specific data (p₁, p₂, p₃, . . . pₙ) to determine and select the trust account key 520 for the broker and property-specific data. Once trust account key 520 has been selected by system 500, buyer is able to send earnest money to designated trust account 530, as determined by the trust account key 520.

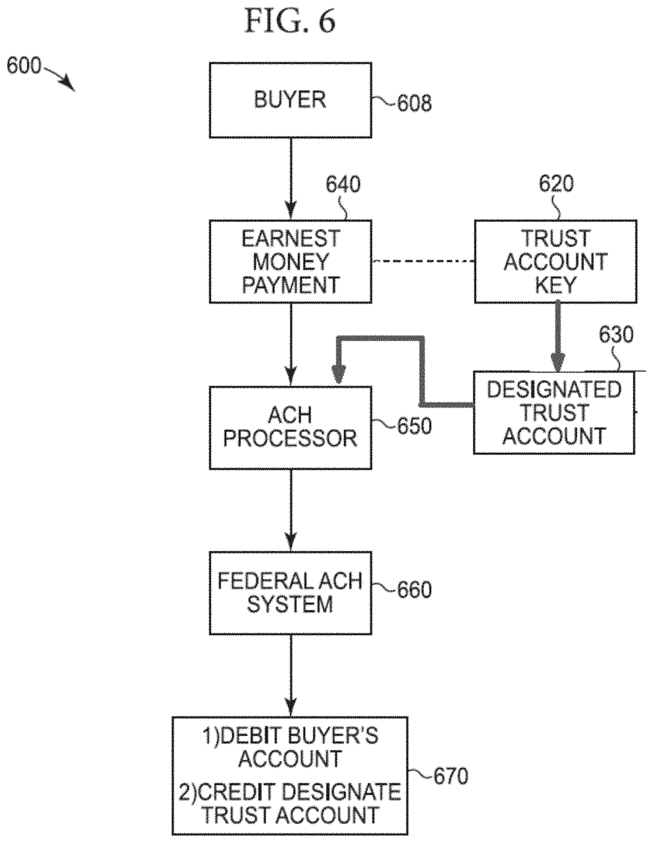

FIG. 6 is a schematic block diagram that illustrates an example of the workflow of the disclosed system and method. Workflow diagram 600 show buyer 608 submitting earnest money payment 640, which includes the trust account key 620 determined previously (see FIG. 5), to ACH processor 650. Buyer 608 provides banking instructions to the system, which are sent as a part of the earnest money payment 640 to the ACH processor 650. The trust account key 620 is used to select the appropriate banking credentials from the system to pass along designated trust account 630 to the ACH processor 650. All of the data from ACH processor 650 is then submitted to Federal ACH banking system 660. Federal ACH banking system 660 then debits buyer's account and credits designated trust account 630.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method of conducting a secure automated real estate financial transaction involving a buyer and a seller comprising the steps of:
registering a designated trust account holder with a web-based transaction system,
wherein the system stores trust account keys in a database in the web-based transaction system, and
wherein the system stores rules for mapping the trust account key to a designated trust account;
providing the buyer with electronic communication with the web-based transaction system;
providing the web-based transaction system with buyer-specific information;
identifying a real estate property that the buyer intends to purchase;
locating the real estate property in a multiple listing system (MLS);
transferring property-specific data from the multiple listing system to the database;
mapping the property-specific data for the property and the buyer-specific information to determine the trust account key of the designated trust account holder stored in the database,
wherein the trust account key identifies a designated trust account and its unique credentials;
the web-based transaction system sending an earnest money request to the buyer;
the buyer providing bank account information and authorization for an ACH payment to the system;
the web-based transaction system passing the buyer-specific information, earnest money amount, and utilizing the trust account key to pass the appropriate credentials to an ACH processor;
the ACH processor creating an ACH transaction and transmitting the ACH transaction to the federal ACH banking system for processing; and
the ACH system debiting the buyer's bank account and crediting the designated trust account.

2. A method of conducting a secure automated real estate financial transaction involving a buyer and a seller according to claim 1, wherein parties involved in the financial transaction are in electronic communication with the web-based transaction system.

3. A method of conducing a secure automated real estate financial transaction involving a buyer and a seller according to claim 2, wherein the parties comprise the buyer, the seller, the buyer's agent, the seller's agent, or the designated trust account holder.

4. A method of conducting a secure automated real estate financial transaction involving a buyer and a seller according to claim 3, wherein the web-based transaction system provides real-time notification of each stage of the financial transaction to the parties in electronic communication with the web-based transaction system.

5. A method of conducting a secure automated real estate financial transaction involving a buyer and a seller according to claim 3, wherein the parties further comprise the ACH processor or the Federal ACH Banking System.

6. A method of conducting a secure automated real estate financial transaction involving a buyer and a seller according to claim 1, wherein the web-based transaction system comprises a system algorithm that determines the designated trust account identified for the specific property.

7. A method of conducting a secure automated real estate financial transaction involving a buyer and a seller according to claim 6, wherein the earnest money from the buyer is paid into the designated trust account in a timeframe required by state statute or by agreement between the buyer and seller in a purchase agreement.

8. A method of conducting a secure automated real estate financial transaction involving a buyer and a seller according to claim 1, wherein the web-based transaction system comprises a system algorithm that determines that there is no designated trust account for the specific property.

9. A method of conducting a secure automated real estate financial transaction involving a buyer and a seller according to claim 7, wherein the web-based transaction system electronically refunds the earnest money to the buyer.

10. An earnest money payment system for a secure real estate transaction comprising:
a computing device in electronic communication with a web-based transaction system,
wherein the web-based transaction system comprises an algorithm that matches a designated trust account to a specific real estate property to be purchased;
a buyer in electronic communication with the computing device who wishes to purchase the specific real estate property,
wherein the buyer, has a bank account and agrees with a seller to sell the specific property to the buyer;
the designated trust account identified by the algorithm for the specific property,
wherein the designated trust account is structured and configured to securely receive and hold an earnest money payment deposited by the buyer; and
a trust account key generated by the designated trust account,
wherein the trust account key, ensures the earnest money payment is securely deposited into the designated trust account,
wherein the system passes the buyer's bank account to an ACH processor in the ACH banking system,
wherein the ACH processor creates the ACH transaction and submits it to the ACH banking system, and
wherein the ACH Banking System debits the buyer's bank account and credits the designated trust account with the earnest money deposited by the buyer.

11. An earnest money payment system according to claim 10, wherein the system comprises a web-based secure transaction system accessible to parties involved in the real estate transaction.

12. An earnest money payment system according to claim 11, wherein the system provides real-time notification of transaction status to the parties involved in the real estate transaction.

13. An earnest money payment system according to claim 11, wherein the system sends accurate, timely, and detailed status information about the earnest money payment to the parties involved in the real estate transaction.

14. An earnest money payment system according to claim 11, wherein the system sends confirmation to the parties involved in the real estate transaction that the system has determined the correct trust account and generates an email for the buyer that contains an earnest money request hyperlink.

15. An earnest money payment system according to claim 14, wherein the earnest money request hyperlink allows the buyer to enter bank account information and to submit the earnest money payment.

16. An earnest money payment system according to claim 10 comprising a designated trust account holder that is charged with receiving and holding the earnest money within the designated trust account.

17. An earnest money payment system according to claim 16, wherein the designated trust account holder is dictated by state statute.

18. An earnest money payment system according to claim 10, wherein the system comprises a software-as-a-service that connects buyers, real estate agents, and designated trust account holders in a secure environment for collecting, processing, tracking, managing, and reporting the earnest money payments.

19. An earnest money payment system according to claim 10, wherein the system collaborates and communicates with other services to supply accurate reporting and data with the ACH banking system.

20. An earnest money payment system according to claim 10, wherein a designated trust holder registers to use the system by completing an authentication and registration process.
